(19) United States
(12) Patent Application Publication
(10) Pub. No.: US 2010/0098240 A1
(43) Pub. Date: Apr. 22, 2010

(54) Method and Apparatus for Facilitating Automatic Sharing of Contact Information Between Communication Devices in a Communication Network

(75) Inventors: Rong Ji, Nanjing (CN); Xun Wang, Beijing (CN)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/252,929

(22) Filed: Oct. 16, 2008

(51) Int. Cl. H04M 3/42

(52) U.S. Cl. 379/218.01

(57) ABSTRACT

A method and apparatus for facilitating automatic sharing of contact information between communication devices. The method includes receiving an input indicating a request for contact information of a third party from a user of the communication device, selecting at least one contact from a contact information database based on an index associated with the selected contact, the index indicating willingness of the selected contact to provide contact information of the third party, automatically generating a request for contact information of the third party, sending the generated request to the remote communication device associated with the selected contact, and receiving contact information of the third party from the remote communication device.

### FIELD OF THE DISCLOSURE

The present disclosure relates generally to a communication network and more particularly to a method for facilitating sharing of contact information between communication devices in a communication network.

### BACKGROUND

Mobile phone users often need to call a person whose contact information is not readily available. Such users usually make a call or manually send a short message service (SMS) message to someone else, for example, a mutual friend, to ask for contact information (e.g. phone number) of the person. Upon receiving the call, the inquired person will look it up in his own phonebook and feedback the phone number. If unfortunately, the inquired person's phone can't support another application while calling, the inquired person needs to hang up his phone, look up the phonebook, and call back the inquirer's phone again to offer the answer, even if the answer may be negative. On the other hand, if the request for contact information is received via an SMS, then the inquired person could miss this SMS if the inquired person is already engaged in a call, and therefore the response to offer the contact information to the inquirer may be delayed. Further, the process of manually finding out the contact information and calling back the inquirer or sending an SMS back to the inquirer to offer the answer may be a tedious work for the inquired person.

Additionally, for the inquirer, the above method can often delay getting the desired contact information, for instance, if the inquirer is busy in some other activity and therefore not being available for sending the requested information in time. Sometimes, the inquired person, even if available, may not always be willing to share the requested information to the inquirer. Therefore, it is unnecessary for the inquirer to request information from such persons who are either not available or not willing to share contact information of a third party.

Accordingly, there is a need for a method and apparatus that addresses all the drawbacks presented above while facilitating sharing of contact information between users of communication devices.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a communication system in accordance with some embodiments.

FIG. 2 is a block diagram illustrating an embodiment of an apparatus employed in communication devices of FIG. 1.

FIG. 3 is a block diagram illustrating an example of a contact list of a contact information database stored in a communication device.

FIG. 4 is a block diagram illustrating an example of a phonebook stored in the contact list of the contact information database.

FIG. 5 is a block diagram of a user interface that facilitates a user of the communication device to manually add contacts to the sharable contact list.

FIG. 6 is a diagram illustrating an example of an inquiry of contact information made by one communication device to other.

FIG. 7 is a flowchart of a method for operating a communication device for providing contact information of a third party in accordance with some embodiments.

FIG. 8 is a flowchart of a method for operating a communication device for obtaining contact information of a third party in accordance with some embodiments.

FIG. 9 is a flowchart of a method for operating a communication device determining a group of an inquired contact in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments.

The apparatus and method components have been represented where appropriate by conventional symbols in the drawings, showing only those specific details that are pertinent to understanding the embodiments so as not to obscure the disclosure with details that will be readily apparent to those of ordinary skill in the art having the benefit of the description herein.

### DETAILED DESCRIPTION

The present disclosure is directed towards a method for facilitating automatic sharing of contact information between communication devices. One aspect of the present invention is to operate a communication device to obtain contact information of a third party from a remote communication device. The communication device receives an input indicating a request for contact information of a third party from a user. Further, the communication device selects at least one contact from a contact information database based on an index associated with the selected contact, wherein the index indicates willingness of the selected contact to provide contact information of the third party. Then, the communication device automatically generates a request for contact information of the third party and sends the generated request to the remote communication device associated with the selected contact. In response to this request, the communication device receives contact information of the third party from the remote communication device.

Another aspect of the present invention is to operate a communication device to provide contact information of a third party to a remote communication device. When the communication device receives a request for contact information of the third party from the remote communication device, the communication device determines whether a user of the remote communication device is authenticated to receive the contact information of the third party from the communication device. The communication device automatically generates a response message including contact information of the third party if the user of the remote communication device is authenticated to receive the contact information of the third party from the communication device. The communication device then sends the generated response message including the contact information of the third party to the remote communication device.

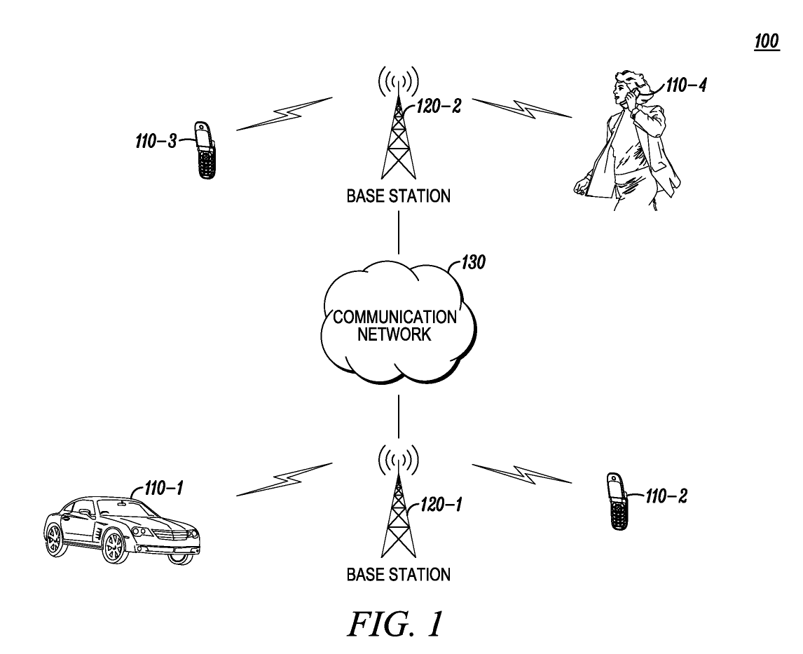

FIG. 1 illustrates a communication system 100 in which methods and apparatus, consistent with the present invention, may be implemented. Specifically, FIG. 1 illustrates a wireless communication system 100 (also referred to as system 100 or communication system 100) including a plurality of communication devices 110, for example, communication devices 110-1 through 110-4. In one embodiment, the communication devices 110 are capable of wirelessly communicating with each other via one or more infrastructure devices 120, for example infrastructure devices 120-1 and 120-2. For example, a communication device 110-1 may wirelessly communicate with another communication device 110-2 via an infrastructure device 120-1. The infrastructure device 120 may be any wireless communication station installed at a fixed location of the wireless communication system 100. The infrastructure device 120 is sometimes referred to as a base station or a radio base station or Node B (in 3G networks), or access point base station. In accordance with some embodiments, the communication devices 110 are capable of communicating with each other via a communication network 130. For example, the communication device 110-1 can communicate with communication devices 110-3 and 110-4 via communication network 130. In some instances, the communication devices 110 can be fixed or mobile and can communicate with each other over a wireless media with or without the support of infrastructure devices 120 or communication network 130. The communication network 130 may include one or more of private networks, public networks, such as the Internet, wireless networks, such as satellite and cellular networks, and local area wireless networks, such as WiFi or Bluetooth networks, local area networks (LANs), wide area networks (WANs), telephone networks, such as the Public Switched Telephone Networks (PSTN), or a combination of networks.

In FIG. 1, four communication devices and two infrastructure devices have been illustrated as connected to communication network 130, for simplicity. In practice, there may be more or less communication devices and infrastructure devices. Further, it is to be understood that the communication system 100 is only a general representation of communications among devices and, thus, may include any number of communication means and/or communication networks. In fact, the communication system 100 may include multiple, distinct networks that have no connection with one another and/or no common communication means. It is also possible for the communication devices 110 to talk to each other directly without use of infrastructure devices or networks using a so called device-to-device ad hoc or mesh connection. In this mode of operation the communication devices may form a communication network among themselves without the need for the infrastructure devices by transmitting and receiving to each other directly. A hybrid system consisting of infrastructure devices coordinated with device-to-device ad hoc connection may also be employed.

The communication devices 110 may include devices, such as mobile phones, mainframes, minicomputers, desktop computers, laptops, notebook computers, personal digital assistants, or the like. For example, in FIG. 1, the communication device 110-4 is illustrated as a mobile device, which is often carried by its user, and thus, remains conveniently available. The communication devices 110 may transmit data over the communication network 130 or receive data from the communication network 130 via a wired, wireless, or optical connection. In accordance with embodiments of the present invention, the wireless communication system 100 facilitates automatic sharing of contact information between communication devices in the wireless communication system 100.

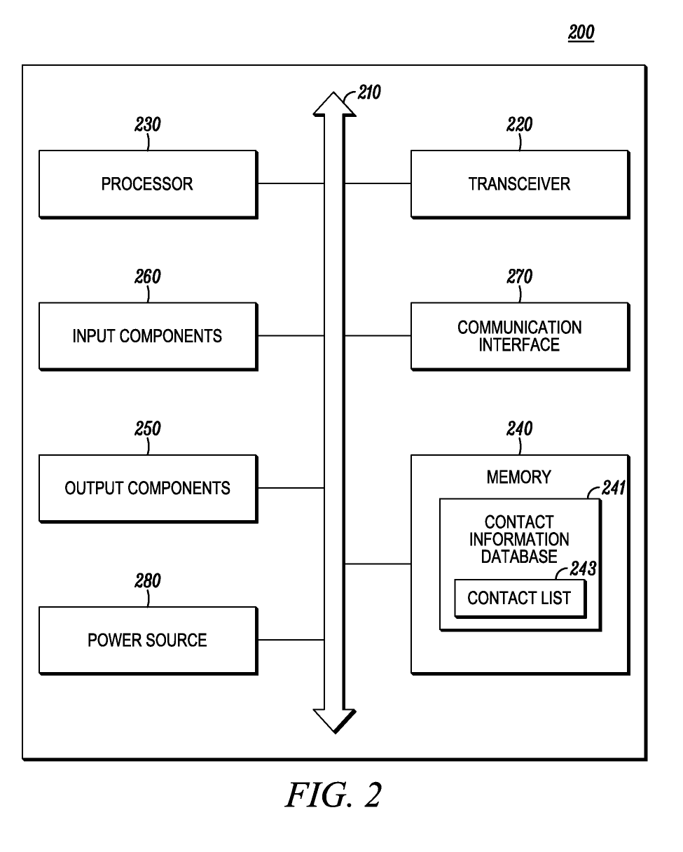

FIG. 2 illustrates a block diagram of an apparatus 200 employed in the communication system 100 of FIG. 1. The apparatus 200, for example, can be implemented in communication devices 110 shown in FIG. 1. The apparatus 200 includes a bus 210, one or more wired or wireless transceivers 220, a processor 230, a memory 240, one or more output components 250, one or more input components 260, a communication interface 270, and a power source 280. Each embodiment may include a user interface that comprises one or more output components 250 and one or more input components 260. The bus 210 may include one or more conventional buses that permit communication among the components of the apparatus 200. The processor 230 may include any type of conventional processor or microprocessor that interprets and executes instructions. Each transceiver 220 may be directly wired to another component or utilize wireless technology for communication, such as, but are not limited to, cellular-based communications such as analog communications (using AMPS), digital communications (using CDMA, TDMA, GSM, iDEN, GPRS, or EDGE), and next generation communications (using UMTS, WCDMA, LTE or IEEE 802.16) and their variants; a peer-to-peer or ad hoc communications such as HomeRF, Bluetooth and IEEE 802.11 (a, b, g or n); and other forms of wireless communication such as infrared technology. Each transceiver 220 may be a receiver, a transmitter or both.

The input components 260 of the apparatus 200 may include an audio input component such as a microphone, and a mechanical input component such as button or key selection sensors, touch pad sensor, touch screen sensor, capacitive sensor, motion sensor, and switch. Likewise, the output components 250 of the internal components of the apparatus 200 may include a variety of video, audio and/or mechanical outputs. Other examples of output components 250 include an audio output component such as a speaker, alarm and/or buzzer, and/or a mechanical output component such as vibrating or motion-based mechanisms.

The memory 240 of the apparatus 200 may be used by the processor 230 to store and retrieve data. The data that may be stored by the memory 240 include, but is not limited to, operating systems, applications, and database. Each operating system includes executable code that controls basic functions of the communication, such as interaction among the components of the internal components of the apparatus 200, communication with external devices via each transceiver 220, and storage and retrieval of applications and data to and from the memory 240. Each application includes executable code that utilizes an operating system to provide more specific functionality for the communication device. Each database includes structured collection of data. In one embodiment, the memory 240 includes contact information database 241 which includes information related to one or more contacts stored in a contact list 243. The contact list 243 includes an entry for each contact including the associated information referred to as contact information. For example, the contact information of a particular contact may include information related to at least one of a phone number, or mailing address, or messaging address, or online availability, or web page address, or office address, or other information associated with the contact.

In accordance with some embodiments, the contact information database 241 is configured to store information that identifies one or more users who are authorized to access contact information corresponding to one or more of the contacts stored in the contact list 243. In one example, the user can either manually include this information in the contact information database or the processor 230 can automatically update this information in the contact information database based on a message received from another user that identifies the willingness of the other user to share contact information of contacts stored within the communication device of the other user. In accordance with some embodiments, an index can be associated with each sharable contact present in the contact list 243, such that the index identifies the willingness of these contacts to share contact information of third parties with the user of this communication device. For example, an entry “*” can be made against those contacts in the contact list who are willing to share contact information of third parties. In one example, the list of all contacts having an entry “*” can be grouped as sharable contact list within the contact list 243, such that, the sharable contact list includes one or more sharable contacts who are willing to share information related to contacts stored in their respective contact list with the user of the communication device.

The communication interface 270 may use transceiver 220 to enable the communication device 110 to communicate with other devices and/or systems. For example, the communication interface 270 may include mechanisms for communicating with another device or system via a network, such as communication network 130. The apparatus 200 also includes a power source 280, such as a power supply or portable battery, for providing power to other internal components of the apparatus.

In accordance with embodiments of the present invention, the processor 230 of a communication device is configured to facilitate obtaining contact information of a third party from a remote communication device. In one example, the processor 230 of the communication device is configured to receive an input from a user of the communication device 110 to obtain contact information of a third party. In response to receiving the user input, the processor 230 is further configured to determine the type of contact information of the third party that the user is interested to obtain. As used herein, the type of contact information of a third party indicates at least one of a phone number, or mailing address, or messaging address, or online availability, or web page address, or office address, or other information associated with the third party. In some embodiments, the processor 230 is further configured to determine a group from the contact information database 241 with which the third party is associated. After determining the group, the processor 230 is configured to select at least one contact from the group that is capable of providing contact information of the third party. In accordance with some embodiments, a contact is selected such that the selected contact is located near to a geographical location of the third party. In one embodiment, the contact is selected based on the index associated with each of the contacts present in the determined group, such that the selected contact is a contact that is willing to share contact information with an inquiring communication device. As used herein, an inquiring communication device or an inquirer refers to a communication device that is operating to automatically obtain contact information of a third party on behalf of a user of the communication device from a remote communication device.

In some embodiments, the processor 230 is configured to automatically generate a request for contact information of the third party. In one embodiment, the generated request includes a unique string that differentiates the request for contact information from normal user initiated communication messages. The processor 230, upon generating the request for contact information, is configured to send the generated request to the selected contact. The processor 230 is further configured to receive a contact information of the third party from the at least one selected contact/inquired communication device. As used herein, the inquired communication device refers to a communication device that is operating to provide contact information of a third party on behalf of a user of the communication device to a remote communication device. In one embodiment, the inquiring communication device may receive a message that either identifies the authentication failure for the requested contact information of the third party or non-availability of the contact information in the inquired communication device. In this case, the processor 230 of the inquiring communication device retries obtaining the contact information of the third party by selecting at least one other contact from the contact list 243.

In another embodiment, when the communication device 110 is the inquired communication device, the processor 230 of the inquired communication is configured to provide contact information of a third party to a remote communication device which is the inquiring communication device. In this embodiment, the processor 230 is configured to receive a request for contact information of the third party from the remote communication device. In some embodiments, the processor 230 is configured to differentiate the received request for contact information from normal user initiated messages based on a unique string included in a received request. In some embodiments, the processor 230 is configured to determine whether the contact information of the user associated with the remote communication device is present in the contact list 243 and send an authentication failure message if the user of the remote communication device is not authenticated to receive the contact information of the third party or if the contact information associated with the user is not present in the contact list 243. In accordance with some embodiments, a remote user is authenticated to receive contact information of the third party when contact information of the remote user is present in the contact information database 241 and further when the remote user is identified as a sharable contact within the sharable contact list of the contact list 243.

In accordance with some embodiments, when the processor 230 determines that the user of the remote communication device is a sharable contact, the processor 230 determines the type of contact information for the third party requested by the user of the remote communication device. In this embodiment, the processor 230 also determines whether the requested type of contact information of the third party is available in the contact information database. The processor 230 sends a contact information non-availability message to the remote communication device when the contact information of the third party is not available in the contact information database 241. The processor 230 is further configured to automatically generate a response message including contact information of the third party when the user of the remote communication device is authenticated to receive the contact information of the third party. The processor 230 is further configured to send the generated contact information response message including the contact information of the third party to the remote communication device.

It is to be understood that FIG. 2 is provided for illustrative purposes only and for illustrating components of a communication device 110 in accordance with the present invention, and is not intended to be a complete schematic diagram of the various components required for a communication device 110. Therefore, a communication device 110 may include various other components not shown in FIG. 2, or may include a combination of two or more components or a division of a particular component into two or more separate components, and still be within the scope of the present invention.

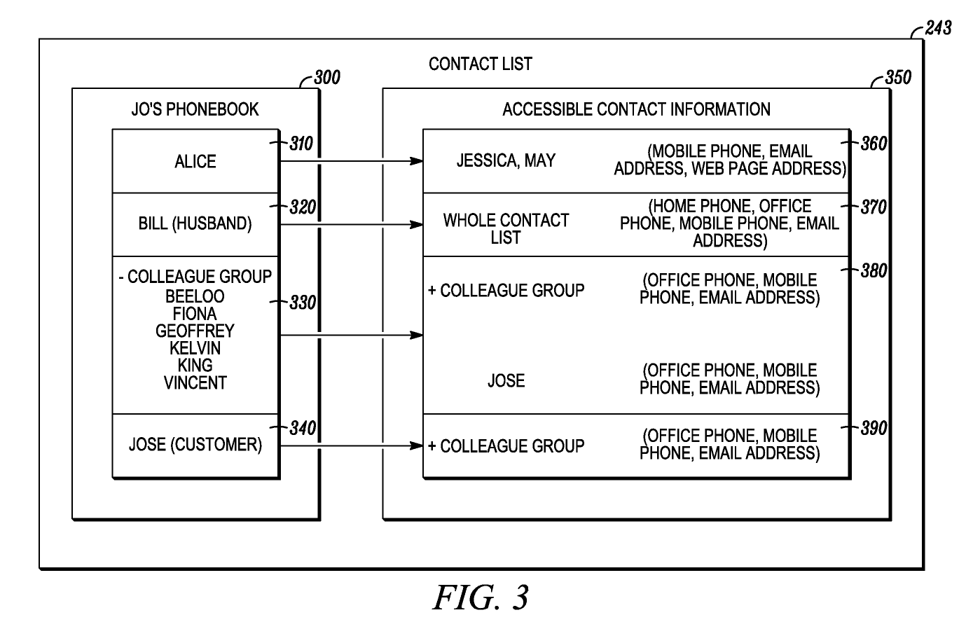

FIG. 3 is a block diagram illustrating an example of a contact list 243 of contact information database 241 stored in a communication device 110. In one embodiment, the contact list 243 includes a phonebook 300 and accessible contact information 350. The phonebook 300 includes contact information of one or more contacts. For example, as illustrated in fields 310, 320, 330, and 340 of FIG. 3, Jo's phonebook includes contact information of contacts namely Alice, Jo's husband namely Bill, Jo's colleagues namely Beeloo, Fiona, Geoffrey, Kelvin, King and Vincent, and Jo's customer namely Jose. In accordance with embodiments of the present invention, the contacts listed in the phonebook 300 are organized as different groups such as family, friends, work team members, professional acquaintances, emergency contacts, and the like. For example, the contacts of Jo's colleagues can be organized within a colleague group as shown in field 330. Similarly, the contacts of Jo's customers can be organized within a customer group as shown in field 340.

The accessible contact information 350 includes information related to the contact information accessible by each contact listed in the phonebook 300. In accordance with some embodiments, the user of the communication device 110 predefines the accessible contact information 350 for each contacts listed in the phonebook 300. In one embodiment, the accessible contact information 350 includes information related to one or more contacts as well as type of contact information of the one or more contacts accessible by each contact listed in the phonebook 300. For example, as illustrated in field 360 of FIG. 3, Jo's contact Alice is able to access contact information such as mobile phone number, email address, and web page address of some of Jo's contacts namely Jessica and May. Further, as illustrated in field 370, Jo's husband Bill is able to access the home phone number, office phone number, and mobile phone number of all the contacts stored in Jo's phonebook. Jo's contacts within the colleague group are able to access (see field 380) office phone numbers, mobile phone numbers, and email addresses of other contacts within the colleague group including Jo's customer namely Jose, while Jose himself is able to access office phone numbers, mobile phone numbers, and email addresses of all the contacts within the colleague group (see field 390).

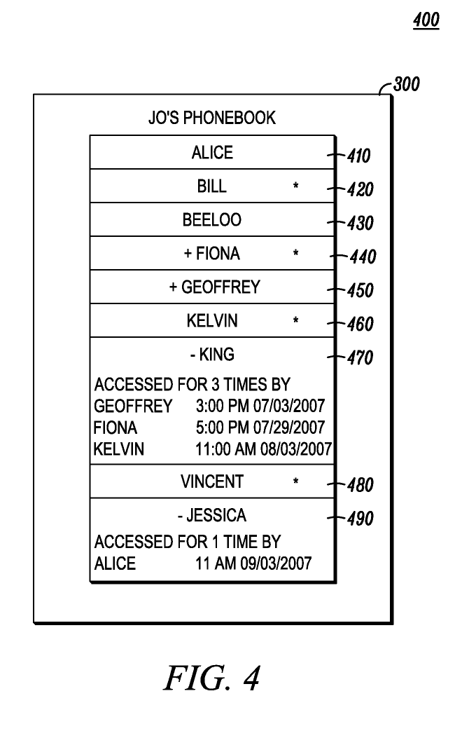

FIG. 4 is a block diagram 400 illustrating an example of a phonebook 300 stored in the contact list 243 of the contact information database 241. In accordance with some embodiments, the phonebook 300 includes a list of contacts (see fields 410 through 490) as well as inquiry statistics corresponding to each contacts listed in the phonebook 300 including information related to other contacts that have accessed a particular contact as well as information related to timestamp of the access. For example, as illustrated in field 470 of FIG. 4, Jo's contact King has been totally accessed three times by Jo's other contacts namely Geoffrey at 3.00 PM on Jul. 3, 2007, Fiona at 5.00 PM on Jul. 29, 2007, and Kelvin at 11.00 AM on Aug. 3, 2007. Also, as illustrated in field 490 of FIG. 4, Jo's contact Jessica has been accessed by Alice one time at 11.00 AM on Sep. 3, 2007. Further, the phonebook 300 also includes a sharable contact list (not shown) including a list of contacts that are willing to share contact information stored in their respective phonebooks with the user of the communication device 110 where the phonebook 300 is stored. In accordance with some embodiments, an index is created for each contact listed in the sharable contact list to identify the willingness of these contacts to share contact information stored in their respective phonebooks with the user of the communication device 110 where the phonebook 300 is stored. In accordance with some embodiments, the index can be created for a particular contact based on a message received from a user associated with the particular contact. In one example, the index can be created by including a “*” against one or more contacts listed in the phonebook who are willing to share contact information of third parties. For example, as illustrated in fields 420, 440, 460, and 480 of FIG. 4, Alice's contacts Bill, Fiona, Kelvin, and Vincent are identified as listed in the sharable contact list that are willing to share contact information stored in their respective phonebooks with Jo.

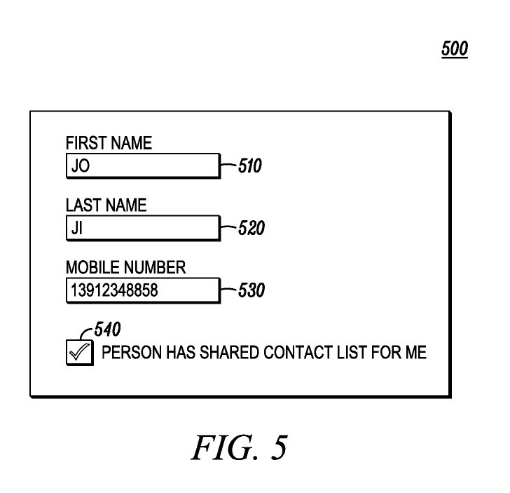

FIG. 5 is a block diagram of a user interface 500 that facilitates a user of the communication device 110 to manually add contacts to the sharable contact list. For example, when a first user (e.g. Jo) sends a message to a second user (e.g. Alice) informing that the first user wishes to be in the sharable contact list of the second user, the second user updates the contact list 243 to include the first user in his sharable contact list. In one embodiment, the user can update his contact list 243 by using the user interface 500 of the communication device 100. For example, as illustrated in FIG. 5, Alice can use the fields 510 and 520 of the user interface 500 to input the first name (Jo) and second name (Ji) of the user wishing to be added to the sharable contact list of Alice. Further, Alice can use the field 530 of the user interface to input contact information e.g. mobile number of Jo and mark the checkbox 540 to update willingness of Jo to share contact information with Alice. It is to be understood that FIG. 5 is provided for illustrative purposes only and for illustrating the concept of manually updating the contact list 243 in accordance with the present invention, and is not intended to be a complete diagram of the various fields required for identifying a user. Therefore, FIG. 5 may include various other fields not shown in FIG. 5, or may include a combination of two or more fields, and still be within the scope of the present invention.

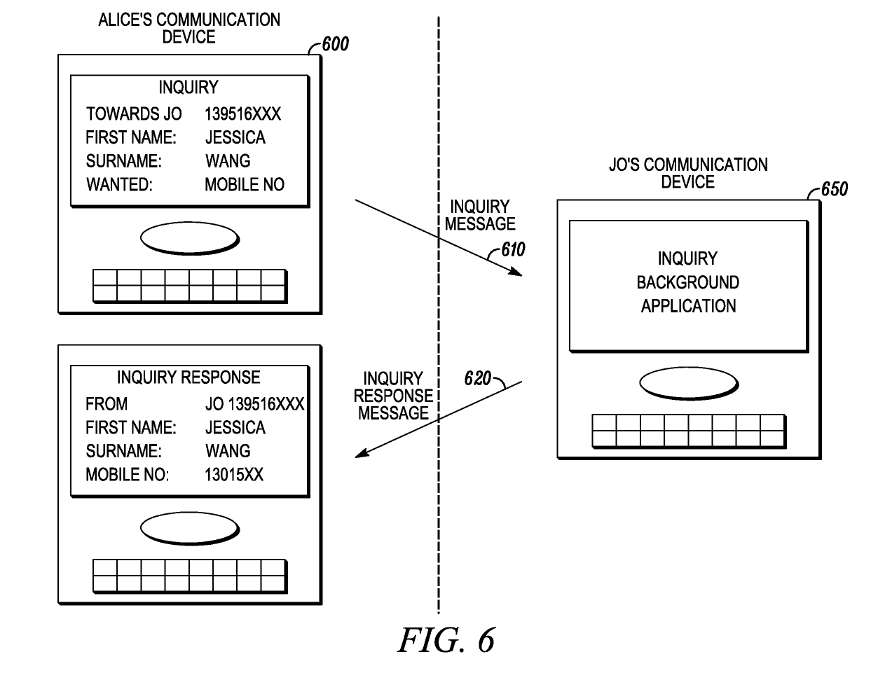

FIG. 6 is a diagram illustrating an example of inquiry for contact information made by one communication device to other. As illustrated in FIG. 6, when Alice requests for mobile number of Jessica, Alice's communication device 600, in accordance with embodiments of the present invention, generates an inquiry message 610 including a request for contact information (mobile number) of Jessica. As previously shown in FIG. 4, since Alice and Jo are in sharable contact list and further Alice is authorized to access Jessica's mobile number (see FIG.3), Alice's communication device sends the generated inquiry message 610 for contact information to Jo's communication device 650. In accordance with some embodiments, the generated inquiry 610 includes a unique string to enable Jo's communication device 650 to determine that the received message is for request of contact information. In response to receiving this message, Jo's communication device 650 checks if Alice is in its sharable contact list and further checks whether Alice is authorized to access Jessica's mobile number based on the accessible contact information 350 stored in its contact list 243. If Jo's communication device 650 determines that Alice is authorized to access Jessica's mobile number, then Jo's communication device 650 accesses Jessica's mobile number from its phonebook 300 and sends an inquiry response 620 including Jessica's mobile number to Alice's communication device 600. On the other hand, if Jo's communication device 650 determines that Alice is not its sharable contact list and/or Alice is not authorized to access Jessica's mobile number, then Jo's communication device 650 sends an inquiry response informing about authentication failure to Alice's communication device 600. In one example, if Jo's communication device 650 determines that Jessica's mobile number is not available in its phonebook 300, then Jo's communication device 650 sends an inquiry response (not shown) informing about the non-availability of Jessica's mobile number to Alice's communication device 600. In accordance with some embodiments, a unique string is included in the inquiry response to enable Alice's communication device 600 to distinguish the inquiry response from normal user initiated communication messages.

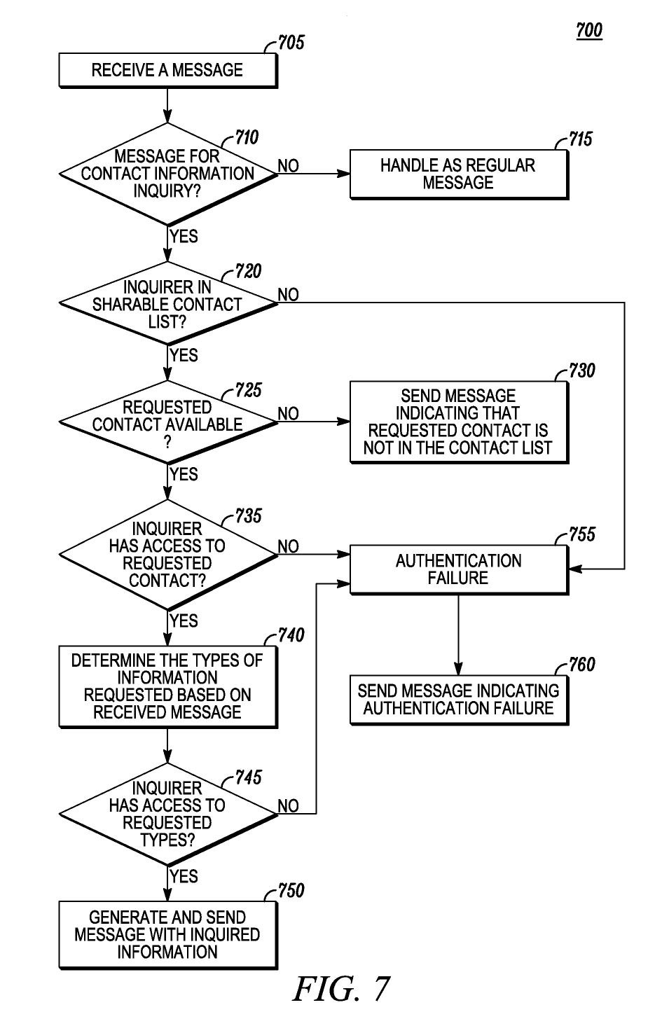

FIG. 7 is a flowchart of a method 700 of operating a communication device 110 for providing contact information of a third party in accordance with some embodiments. The method 700 begins at step 705 where a communication device 110 receives a message from a remote communication device. Upon receiving the message, the communication device 110, at step 710, determines whether the message received from the remote communication device is an inquiry for contact information. In one embodiment, the communication device 110 determines whether the received message includes a unique string to determine whether the message received from the remote communication device is an inquiry for contact information. If the communication device 110 determines that the received message does not include a unique string, then the communication device 110 concludes that it is a user initiated communication message and handles the message as a regular message as shown in step 715. Returning to step 710, when the communication device 110 determines that the received message is an inquiry for contact information, for example, by determining the existence of a unique string in the received message, the communication device 110 proceeds to step 720 to determine whether the inquirer is a contact in the sharable contact list. As used herein, the term “inquirer” refers to a contact associated with a remote communication device that is making the request for contact information of a third party.

When the communication device 110 determines that the inquirer is not in the sharable contact list, the communication device 110 concludes at step 755 that there is an authentication failure indicating that the inquirer is not eligible to access any contact information from the communication device 110 and further proceeds to step 760 to send a message to the inquirer indicating the authentication failure.

Returning to step 720, when the communication device 110 determines that the inquirer is in the sharable contact list, the communication device 110 proceeds to step 725 to determine whether there is an entry for the requested contact in the contact list 243 of the communication device 110. When the communication device 110 determines that the requested contact is not available in the contact list 243 of the communication device 110, the communication device 110 sends a message to the inquirer indicating that the contact information for the requested contact is not available. Returning to step 725, when the communication device 110 determines that the contact information for the requested contact is available in the contact list, the communication device 110 proceeds to step 735 to determine whether the inquirer has access to the requested contact. If the communication device 110 determines that the inquirer does not have access to the requested contact, the communication device 110 concludes at step 755 that there is an authentication failure indicating that the inquirer does not have access to information associated with the requested contact, and further proceeds to step 760 to send a message to the inquirer indicating the authentication failure.

Returning to step 735, when the communication device 110 determines that the inquirer has access to the requested contact, the communication device 110 determines the type of information requested for the contact based on the received message as shown in step 740. After determining the required type of contact information, the communication device 110 proceeds to step 745 to determine whether the inquirer has access to the type of information requested for the contact. If the communication device 110 determines that the inquirer does not have access the requested type of contact information, the communication device 110 concludes at step 755 that there is an authentication failure indicating that the inquirer does not have access to the requested type of contact information, and further proceeds to step 760 to send a message to the inquirer indicating the authentication failure.

Returning to step 745, when the communication device 110 determines that the inquirer has access to the requested type of contact information, at step 750, the communication device 110 generates a response message including the inquired contact information, and sends the generated response message to the inquirer.

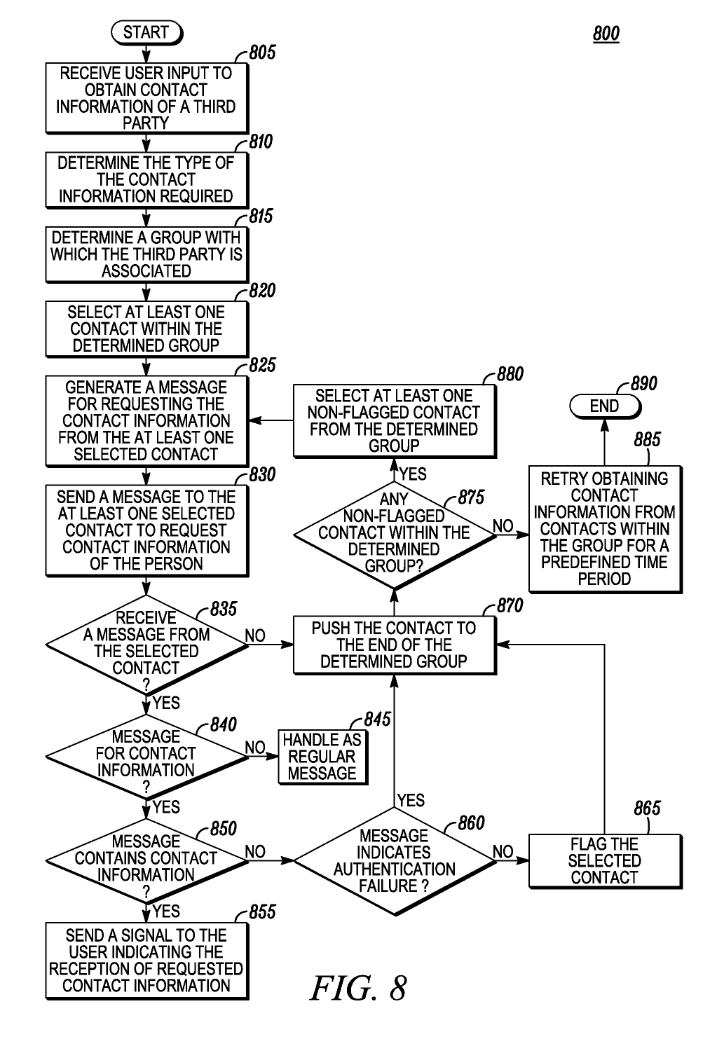

FIG. 8 is a flowchart of a method 800 of operating a communication device 110 for obtaining contact information of a third party in accordance with some embodiments. The method 800 begins at step 805 where a communication device 110 receives a user input indicating a request to obtain contact information of a third party. In response to this user input, the communication device 110 proceeds to step 810 to determine the type of the contact information needed to be obtained for the user of the communication device 110. In one embodiment, the communication device 110 manually obtains the type of contact information requested for the third party from the user. In alternative embodiments, the communication device 110 determines the type of contact information required for the third party based on information predefined by the user. For example, the user may predefine, based on his requirement, that one or more or all of the types of contact information be obtained in response to a request for contact information of a third party.

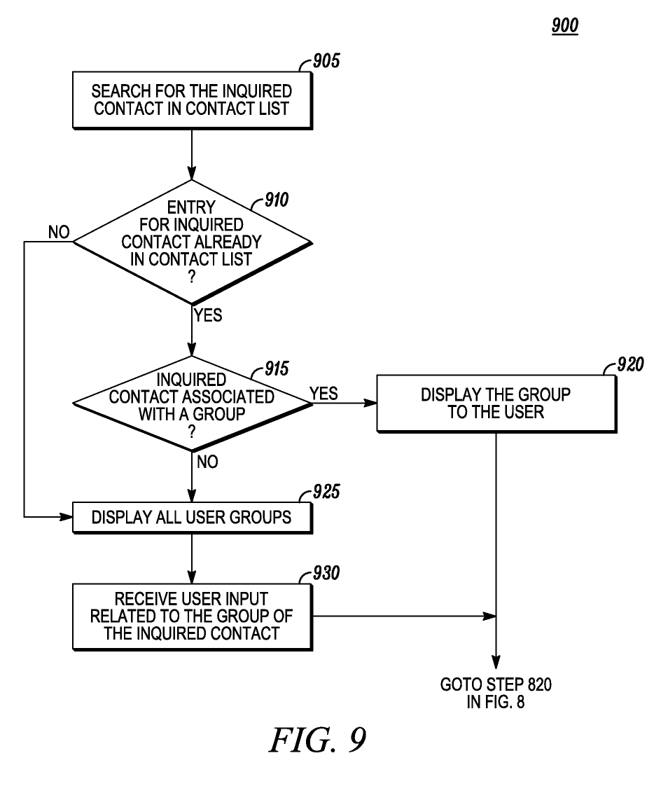

After determining the required type of contact information, the communication device 110, at step 815, determines a group with which the third party is associated. In one embodiment, the communication device 110 can obtain information related to the group with which the third party is associated from the user (see FIG. 9). For example, referring to FIG. 3, when King, one of the colleagues of Jo, requests to obtain contact information of Kelvin from Jo, King's communication device may obtain user input from King indicating that the contact Kelvin is King's colleague belonging to a “colleague” group. This input regarding the group of the third party (Kelvin) enables King's communication device to select one or more contacts within the “colleague” for obtaining contact information of Kelvin.

Returning to step 815, the communication device 110 upon determining a group with which the third party is associated, selects at least one contact organized within the determined group at step 820. The selection of contacts from within a group instead of randomly from within the entire contact list 243 increases the success rate of King's communication device obtaining Kelvin's contact information. In other words, King's contacts within his “colleague” group are more likely to have the contact information of his other colleague namely Kelvin, when compared to other contact groups. In one embodiment, the communication device 110 selects the at least one contact based on the index associated with the at least contact, wherein the index indicates the willingness of the selected contact within the group to provide contact information of a third party to the communication device 110. In one embodiment, the communication device 110 may organize the contacts within a particular group, in the order of the willingness of the contacts to provide contact information of a third party and/or a rate at which the communication device 110 is successful in obtaining contact information of third parties from these contacts. The organization of contacts in a particular order enables the communication device 110 to selectively send a request for contact information to only those contacts in order to increase the success rate and further improve the time period at which the requested contact information for the third party can be obtained.

After selecting at least one contact from the determined group, the communication device 110 proceeds to step 825 to generate a request for contact information of the third party for a remote communication device associated with the selected contact. In accordance with some embodiments, the communication device 110 may include a unique string in the request to enable the remote communication device to distinguish the request for contact information from a normal user initiated communication message. After generating the request, the communication device 110 sends the generated request to the remote communication device associated with the selected contact, and waits for a predefined time period to receive a response from the remote communication device. During this predefined time period, the communication device 110 continues to check if it has received a message from the remote communication device. If the predefined time period lapses, and if the communication device 110 has not received any message from the remote communication device, then the communication device 110 proceeds to step 870 to push the selected contact associated with the remote communication device to the end of the determined group. In other words, the communication device 110 sets a low priority for the contact to indicate that this contact will be selected at a lower priority in the future when compared with other contacts ordered within a group, for obtaining contact information. The processing of the communication device 110 then continues to step 875.

Returning to step 835, when the communication device 110 receives a message from the remote communication device, the communication device 110 determines whether the received message is in response to the request for contact information. In one embodiment, the communication device 110 determines whether the received message includes a unique string to determine if the received message is a response for contact information. If the communication device 110 determines that the received message is not a response for contact information, the communication device 110 handles the received message as a regular message as shown in step 845. Returning to step 840, when the communication device 110 determines that the received message is a response for contact information, for example, based on the existence of the unique string in the received message, the communication device 110 proceeds to step 850 to determine if the message includes inquired contact information. At step 855, when the communication device 110 determines that the message includes inquired contact information, the communication device 110 sends a signal to the user of the communication device 110 indicating the reception of the inquired contact information. In one embodiment, the communication device 110 displays the received contact information to the user of the communication device 110. In accordance with some embodiments, the communication device 110 automatically adds the received contact information of the third party in the contact list 243 and further organizes the contact of third party within the appropriate group.

Returning to step 850, when the received message does not include contact information, the communication device 110 proceeds to step 860, to determine whether the message indicates an authentication failure. In accordance with some embodiments, the communication device 110 may receive a message indicating an authentication failure either when the contact associated with the communication device 110 is not in the sharable contact list of the remote communication device or when the inquirer does not have access to any information associated with the requested contact. Next, at step 865, the communication device 110 flags the selected contact associated with the remote communication device from which the communication device 110 has received a message indicating authentication failure. As used herein, the flagging of a particular contact within the contact list 243 indicates that the attempt to obtain contact information of the third party from this particular contact has failed. Next, at step 870, the communication device 110 pushes the selected contact associated the remote communication device to the end of the user group. In other words, the communication device 110 sets a low priority for the contact to indicate that this contact will be selected at a lower priority in the future when compared with other contacts ordered within a group for the purposes of obtaining contact information.

Next, at step 875, the communication device 110 determines whether there is at least one contact within the determined group of the third party which is not flagged. In other words, the communication device 110 determines if there are more contacts within the group that has not been contacted yet for obtaining contact information of the third party. If the communication device 110 determines that there are one or more contacts without a flag, then at step 880, the communication device 110 selects at least one contact from the non-flagged contacts within the group and the processing of the communication device 110 continues to step 825. In one embodiment, the communication device 110 can select one or more non-flagged contacts from the group based on the order in which the non-flagged contacts are organized within the group.

Returning to step 875, when the communication device 110 determines that there are no flagged contacts within the group, the communication device 110, at step 885, retries obtaining the contact information from contacts within the group, in accordance with embodiments of the present invention. In one embodiment, the number of retries for obtaining contact information of a third party from a particular contact can be predefined. In one embodiment, the communication device 110 displays the flagged contacts to the user of the communication device 110 to manually obtain user input related to one or more of the flagged contacts that can be selected for obtaining inquired contact information. If, either the number of the retries for obtaining the contact information is completed or a predefined time period for obtaining contact information from contacts organized within a group lapses, then the communication device 110 at step 890 stops performing the operation of obtaining the inquired contact information, and may send an appropriate signal to the user of the communication device 110 indicating the inability of the communication device 110 to obtain the inquired contact information.

FIG. 9 is a flowchart of a method 900 for operating a communication device 110 to determine a group of an inquired contact in accordance with some embodiments. The method 900 begins at step 905 where a communication device 110 searches the contact list 243 and further determines at step 910 if an entry for the contact, for which the contact information is being inquired, is already included in the contact list 243. If the communication device 110 determines that the entry for the inquired contact is already included in the contact list 243, then the communication device 110, at step 915, determines if the inquired contact is organized within a particular group within the contact list 243. When the communication device 110 determines that the inquired contact is organized within a group, the communication device 110, at step 920 optionally displays the determined group with which the inquired contact is associated to the user, so that the user of the communication device 110 is given the option of manually changing the group of the inquired contact, if needed. Returning to steps 910 and 915, if either the entry for the inquired contact is not already included in the contact list 243 or the inquired contact is not already associated with a particular group, then the communication device 110 proceeds to step 925 to display all the groups listed in the contact list 243 to enable the user to manually input information related to the group with which the inquired contact can be associated. Next, at step 930, the communication device 110 receives user input related to the group with the inquired contact can be associated, and proceeds to step 820 of FIG. 8 to select at least one contact from the determined group for obtaining contact information of the inquired contact.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a” , “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We claim:

1. A method of operating a communication device for obtaining contact information of a third party from a remote communication device, comprising:
receiving an input indicating a request for contact information of a third party from a user of the communication device;
selecting at least one contact from a contact information database based on an index associated with the selected contact, the index indicating willingness of the selected contact to provide contact information of the third party;
automatically generating a request for contact information of the third party;
sending the generated request to the remote communication device associated with the selected contact; and
receiving contact information of the third party from the remote communication device.

2. The method of claim 1, wherein selecting at least one contact from the contact information database further comprises:
determining a group with which the third party is associated; and
selecting the at least one contact from the determined contact group.

3. The method of claim 1, wherein automatically generating a request for contact information comprises including a unique string to the generated request to differentiate the request for contact information from normal user initiated communication messages.

4. The method of claim 1, wherein receiving an input indicating a request for contact information of a third party from a user of the communication device further comprises receiving an input including information related to at least one type of contact information requested for the third party.

5. The method of claim 4, wherein the type is at least of a phone number, or mailing address, or messaging address, or online availability, or web page, or office address, or other contact information associated with the third party.

6. The method of claim 4, wherein automatically generating a request for contact information comprises including information related to the at least one type of contact information requested for the third party.

7. The method of claim 1, wherein receiving contact information further comprises automatically adding the received contact information of the third party to the contact information database.

8. The method of claim 1, wherein receiving contact information further comprises displaying the received contact information of the third party to the user of the communication device.

9. The method of claim 1, further comprising:
receiving at least one of an authentication failure message or contact information non-availability message from the remote communication device; and
attempting to obtain the contact information of the third party from at least one other contact in the contact information database.

10. The method of claim 9, wherein attempting to obtain the contact information of the third party comprises repeating the steps of selecting, generating, and sending till the request for contact information of the third party is successful.

11. The method of claim 1 further comprises:
receiving a message from a new contact indicating willingness of the new contact to share contact information of contacts stored within a communication device of the new contact; and
storing information in the contact information database indicating the willingness of the new contact to share contact information.

12. The method of claim 1, wherein the selected contact is located within a geographical area of the third party.

13. A method of operating a communication device for providing contact information of a third party to a remote communication device, comprising:
receiving a request for contact information of the third party from the remote communication device;
automatically generating a response message including contact information of the third party when a user of the remote communication device is authenticated to receive the contact information of the third party from the communication device; and
sending the generated response message including the contact information of the third party to the remote communication device.

14. The method of claim 13, further comprising differentiating the received request for contact information from a normal user initiated message based on a unique string included in the received request.

15. The method of claim 13, further comprising determining whether the user of the remote communication device is listed in a sharable contact list of the communication device.

16. The method of claim 15, further comprising sending an authentication failure message to the remote communication device when the user of the remote communication device is not listed in a sharable contact list of the communication device.

17. The method of claim 13, further comprising
determining that the contact information of the third party is available in the contact information database, and
sending a contact information non-availability message to the remote communication device when the contact information of the third party is not available in a contact information database of the communication device.

18. The method of claim 13, wherein automatically generating a response message including contact information of the third party comprises
determining a type of contact information requested for the third party; and
including the requested type of contact information of the third party in the generated response message.

19. An apparatus for obtaining contact information of a third party from a remote communication device comprising:
a memory for maintaining a contact information database including a list of contacts;
a processor configured to receive an input indicating a request for contact information of a third party from a user of a communication device, select at least one contact from the contact information database based on an index associated with the selected contact, the index indicating willingness of the selected contact to provide contact information of the third party, and generate a request for contact information of the third party; and
a transceiver configured to send the generated request for contact information to the remote communication device associated with the selected contact, and receive the contact information of the third party from the remote communication device.

20. The apparatus of claim 19, wherein the processor is further configured to include a unique string to the generated request for contact information to enable the remote communication device to differentiate the request for contact information from normal user initiated communication messages.
